(19) United States
(12) Patent Application Publication
(10) Pub. No.: US 2016/0307192 A1
(43) Pub. Date: Oct. 20, 2016

(54) Secure Digital Asset Distribution System and Methods

(71) Applicant: Todd Frankson, New Bern, NC (US)

(72) Inventor: Todd Frankson, New Bern, NC (US)

(21) Appl. No.: 14/851,428

(22) Filed: Sep. 11, 2015

Related U.S. Application Data
(60) Provisional application No. 62/148,792, filed on Apr. 17, 2015.

(51) Int. Cl. G06Q 20/38; G06Q 20/02

(52) U.S. Cl. CPC G06Q 20/3829; G06Q 20/027

(57) ABSTRACT

A secure digital asset and licensing distribution system and methods is disclosed. The secure digital asset and licensing distribution system comprises a multi-part software system that includes, but is not limited to, a server (e.g., Internet server), a user database, a media database, and a file server. A media pack algorithm resides on the server. Further, a distributed software component of the media pack algorithm resides on the personal computing devices of users. The media pack algorithm is used to create media packs comprising one or more digital assets (e.g., digital images, videos, music), wherein the media packs are encrypted for access only by the purchasing user. A method of creating/utilizing a media pack is provided.

### CROSS-REFERENCE TO RELATED APPLICATION

This utility patent application claims the benefit of U.S. Provisional Patent Application No. 62/148792, entitled “Secure Digital Asset Distribution System and Methods,” filed on Apr. 17, 2015; and incorporated herein by reference in its entirety.

### BACKGROUND

Controlled distribution of media is difficult. In today's connected world digital media (e.g., photos, videos, and music) may be easily distributed and disseminated. For example, digital media may be easily passed from a device to another via public and private networks (such as the Internet and/or cellular networks), all the while ownership and/or publication rights are frequently ignored.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a block diagram of an example of the presently disclosed secure digital asset distribution system comprising a media pack algorithm;

FIG. 2 shows an example of a graphical user interface (GUI) of the presently disclosed secure digital asset distribution system, wherein examples of media packs are displayed in the GUI;

FIG. 3 illustrates a block diagram showing more details of the media pack algorithm of the presently disclosed secure digital asset distribution system;

FIGS. 4 and 5 are screenshots of the GUI 200, according to exemplary embodiments;

FIG. 6 is a more detailed illustration of the operating environment, according to exemplary embodiments;

FIG. 7 illustrates payment processing, according to exemplary embodiments;

FIGS. 8-9 illustrate encryption of the media pack 122, according to exemplary embodiments;

FIG. 10 illustrates profile storage, according to exemplary embodiments;

FIG. 11 illustrates a flow diagram of an example of a method of creating a media pack using the presently disclosed secure digital asset distribution system;

FIGS. 12-25 show various views of the GUI of the presently disclosed secure digital asset distribution system; and

FIGS. 26-31 illustrates still more exemplary operating environments and embodiments.

### SUMMARY OF THE INVENTION

In one embodiment, the invention provides a method for secure digital asset distribution. The method may include receiving, by a server, an electronic confirmation associated with a financial transaction, the confirmation may include a data field containing a payment-gateway-assigned identification associated with the financial transaction; creating, by the server, an encryption key; and encrypting, by the server, a media pack using the encryption key to generate an encrypted media pack, wherein, the encrypted media pack is keyed to a specific user's account. The method may further include randomly selecting, by the server, characters contained within the data field containing the payment-gateway-assigned identification, and wherein the encryption key is created using the characters randomly selected from the data field containing the payment-gateway-assigned identification. The method may further include receiving a cardholder's name associated with the financial transaction. The method may further include randomly selecting additional characters contained within the cardholder's name. The method may further include creating the encryption key using the additional characters randomly selected from the cardholder's name. The method may further include generating a user name using the characters from the data field containing the payment-gateway-assigned identification. The method may further include generating a purchase code using the characters from the data field containing the payment-gateway-assigned identification. The method may further include generating a code using the characters from the data field containing the payment-gateway-assigned identification.

In another embodiment, the invention provides a system for secure digital asset distribution. The system may include a processor; and a memory storing instructions that when executed cause the processor to perform operations. The operations may include receiving an electronic confirmation of a financial transaction, the confirmation comprising a data field containing a payment-gateway-assigned identification associated with the financial transaction; creating an encryption key; and generating an encrypted media pack using the encryption key, and wherein, the encrypted media pack is keyed to a specific user's account. The operations may further include randomly selecting, by the server, characters contained within the data field containing the payment-gateway-assigned identification, and wherein the encryption key is created using the characters randomly selected from the data field containing the payment-gateway-assigned identification. The operations may further include receiving a cardholder's name associated with the financial transaction. The operations may further include randomly selecting additional characters contained within the cardholder's name. The operations may further include creating the encryption key using the additional characters randomly selected from the cardholder's name. The operations may further include generating a user name using the characters from the data field containing the payment-gateway-assigned identification. The operations may further include generating a purchase code using the characters from the data field containing the payment-gateway-assigned identification. The operations may further include generating a code using the characters from the data field containing the payment-gateway-assigned identification.

In yet another embodiment, the invention provides a memory device storing instructions that when executed cause a processor to perform operations. The operations may include receiving an electronic confirmation of a financial transaction, the confirmation comprising a data field containing a payment-gateway-assigned identification associated with the financial transaction; creating an encryption key; and generating an encrypted media pack using the encryption key, and wherein, the encrypted media pack is keyed to a specific user's account. The operations may further include randomly selecting, by the server, characters contained within the data field containing the payment-gateway-assigned identification, and wherein the encryption key is created using the characters randomly selected from the data field containing the payment-gateway-assigned identification. The operations may further include receiving a cardholder's name associated with the financial transaction. The operations may further include randomly selecting additional characters contained within the cardholder's name. The operations may further include creating the encryption key using the additional characters randomly selected from the cardholder's name. The operations may further include generating a user name using the characters from the data field containing the payment-gateway-assigned identification. The operations may further include generating a purchase code using the characters from the data field containing the payment-gateway-assigned identification.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the exemplary embodiments set forth herein; rather, these exemplary embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific exemplary embodiments disclosed and that modifications and other embodiments are intended to be included within the scope of the appended claims.

In some exemplary embodiments, the presently disclosed subject matter provides a secure digital asset and licensing distribution system and methods. The presently disclosed secure digital asset and licensing distribution system and methods provide a means by which owners, creators, and/or publishers of digital media may control the distribution of their digital assets. The digital assets can be any digital media, such as, but not limited to, digital images, videos, and music.

The presently disclosed secure digital asset and licensing distribution system comprises servers, routers, and other networking components that receive, execute, and/or store a media pack algorithm and/or distributed software components of the media pack algorithm. Some or all of the media pack algorithm may also reside on client devices of users. The media pack algorithm is used to create media packs comprising one or more digital assets (e.g., digital images, videos, music), wherein the media packs are encrypted for access only by a purchasing user.

For the purpose of illustration, exemplary embodiments are described herein below with respect to processing of digital images (or digital photos). However, exemplary embodiments are not limited to processing digital images only. Exemplary embodiments may be applied or adapted to any digital media files, regardless of file type, extension, formatting, or size.

In some embodiments, the presently disclosed secure digital asset and licensing distribution system and methods allow a user to access an electronic database of digital images, then search for a particular type of digital images, and then download a packet of digital images, called a media pack, wherein the contents of the media pack meets a search criteria. The digital images, for example, in the media pack can be used as wallpaper, a screen saver, or background images on the user's computer, smartphone, tablet, or other mobile device executing the media pack algorithm.

An aspect of the presently disclosed secure digital asset and licensing distribution system and methods is that the media pack, which can be a photo packet, is encrypted and keyed to a specific user's account. That is, after the user completes a registration process, any media pack purchased (using the specific user's account) may be encrypted using information generated during the initial registration process. A decryption key may also be generated, also based on information generated during the initial registration process. Consequently, if an attempt is made to move, copy, or transfer the media pack to a different user's device, exemplary embodiments prevent decryption of the media pack. In simple words, the key may be based on unique information generated during the initial registration process, which is unknown to other user accounts. The media pack thus cannot be decrypted without the information generated during the initial registration process. Any device, associated with a different user, is thus unable to decrypt the media pack, thus thwarting retrieval and playback of the digital media contained within. Accordingly, exemplary embodiments allow owners, creators, and/or publishers of digital media to control use, even after distribution.

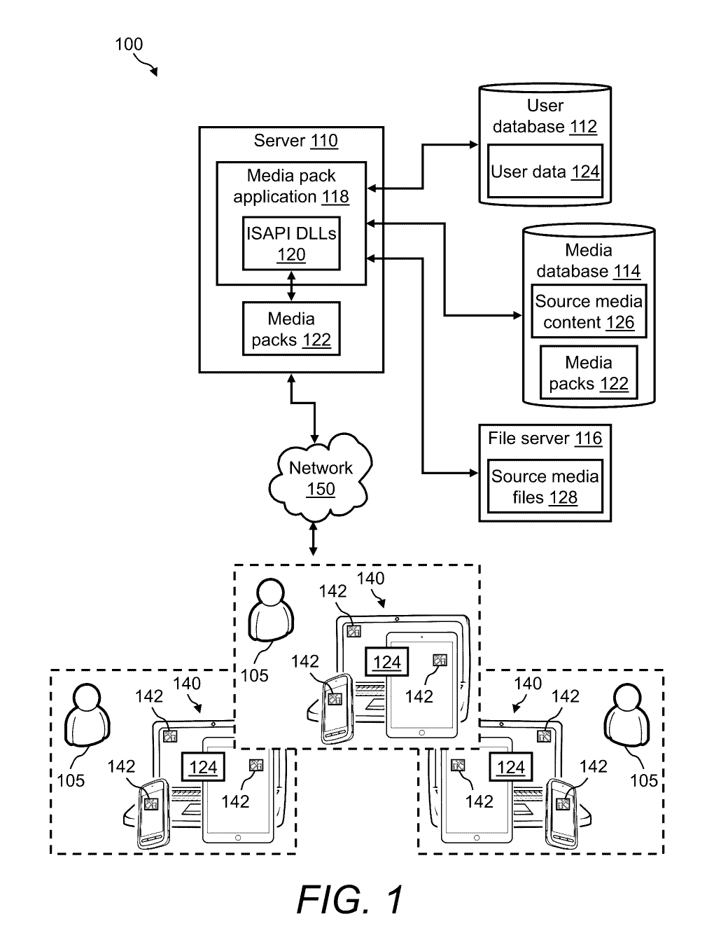

Referring now to FIG. 1 is a block diagram of an example of the presently disclosed secure digital asset distribution system 100 comprising a media pack algorithm 118. In this example, secure digital asset distribution system 100 is a multi-part software system that includes a server 110, a user database 112, a media database 114, and/or a file server 116. Server 110 can be any centralized server that can be accessed, for example, via the Internet. The media pack algorithm 118 is running on server 110. Media pack algorithm 118 is, for example, a software application for managing securely the distribution of digital assets and/or licenses of digital assets. Namely, using media pack algorithm 118, secure digital asset distribution system 100 provides a means by which owners, creators, and/or publishers of digital media may control the distribution of their assets.

Media pack algorithm 118 may include a set of Internet server application programming interface (ISAPI) DLLs 120. ISAPI DLLs 120 are used to create and manage media packs 122, wherein each of the media packs 122 includes, for example, a collection of user-selected digital images. A plurality of users 105 are associated with secure digital asset distribution system 100. For example, secure digital asset distribution system 100 can be a subscription-based system by which users 105 are granted access to the system. Each different user 105 may access the secure digital asset distribution system 100 using a personal computing device 140 (which later paragraphs will explain). Each different user 105 is uniquely associated with user data 124. The user data 124 is stored in an electronic user database 112. The contents of user data 124 can include any information about users 105, such as, but not limited to, user profile information, login credentials, purchase information and history, any account information, and the like.

Generally, media pack algorithm 118 functions on server 110, which can be, for example, an Internet server, a cluster of servers, and/or a virtual instantiation of a cloud server. User database 112 and media database 114 can be, for example, electronic databases having electronic relational database associations (e.g., Oracle, MSSQL). Media pack algorithm 118 uses, for example, standard file/directory structure, with ISAPI DLLs 120. ISAPI DLLs 120 can be used for interfacing with the digital asset provider via application programming interfaces (APIs) or other transport protocol (e.g., Http, Https, Ftp) for connecting to user database 112, media database 114, and/or file server 116, as well as handling all processes of web pages for user interaction including, but not limited to, display rendering, user validation, user login, and the creation of media packs 122. One source of digital media for creating media packs 122 is source media content 126 at media database 114. Another source of digital media for creating media packs 122 is source media files 128 at file server 116. Yet another source of digital media for creating media packs 122 may be any network address associated with any networked component via a communications network (such as the Internet).

Each of the users 105 may have one or more personal computing devices 140 that can be connected to server 110 via network 150. Network 150 can be, for example, any local area network (LAN) or wide area network (WAN) for connecting to the Internet. The personal computing devices 140 of users 105 may connect to network 150 by any wired or wireless means. The personal computing devices 140 of users 105 can be any types of computing devices, such as, but not limited to, a desktop computer, a laptop computer, a mobile/handheld computer, a tablet device (e.g., iPad or Android tablet), a smart phone (e.g., iPhone or Android phone).

A client-side media pack algorithm 142 may be installed and running on each of the personal computing devices 140. The client-side media pack algorithm 142 may be a distributed software component of the server-side media pack algorithm 118 executed at server 110, wherein the client-side media pack algorithm 142 functions on personal computing devices 140. The client-side media pack algorithm 142 can be, for example, a desktop application or a downloaded mobile application. In one example, personal computing devices 140 and server 110 operate in a client-server type of system architecture. For example, the server-side media pack algorithm 142 (the client component) at each of the personal computing devices 140 is the counterpart to the server-side media pack algorithm 118 (the server component) at server 110.

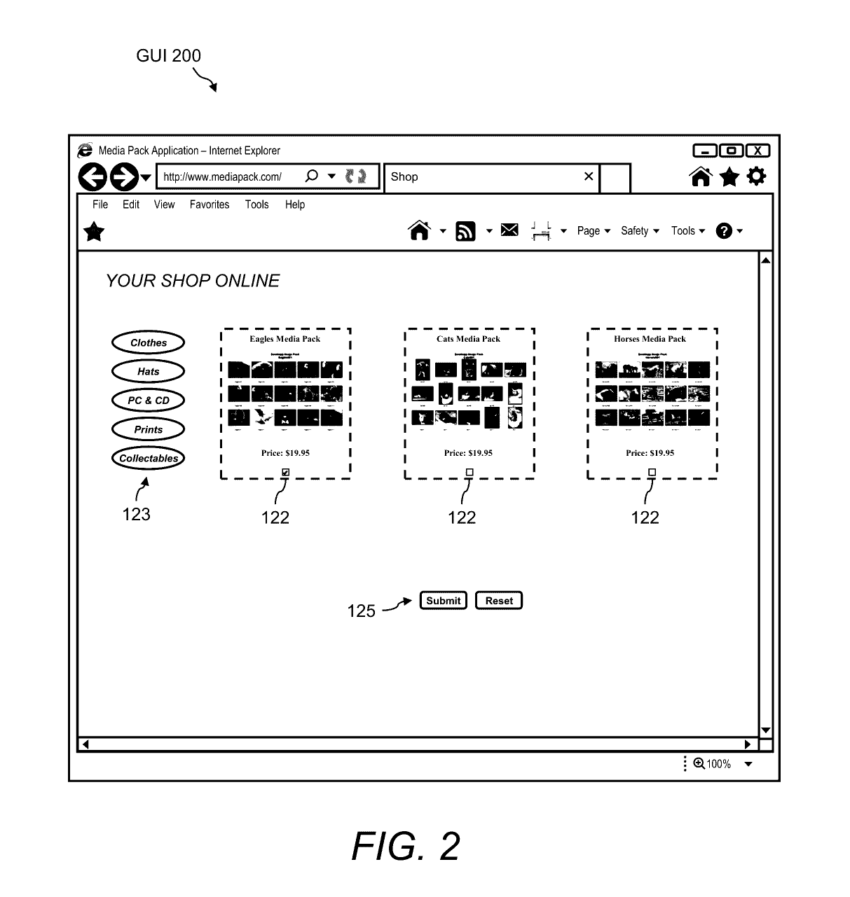

Referring now to FIG. 2 is a view of an example of a graphical user interface (GUI) 200 of the presently disclosed secure digital asset distribution system 100, wherein examples of media packs 122 are displayed in the GUI 200. In one example, GUI 200 may be generated by any web browser. In this example, an eagles media pack 122, a cats media pack 122, and a horses media pack 122 have been created using secure digital asset distribution system 100. Using GUI 200, users 105 have the option to purchase the eagles media pack 122, cats media pack 122, and/or horses media pack 122. FIG. 2 also shows that GUI 200 may display a set 123 of category buttons as well as any other control buttons 125.

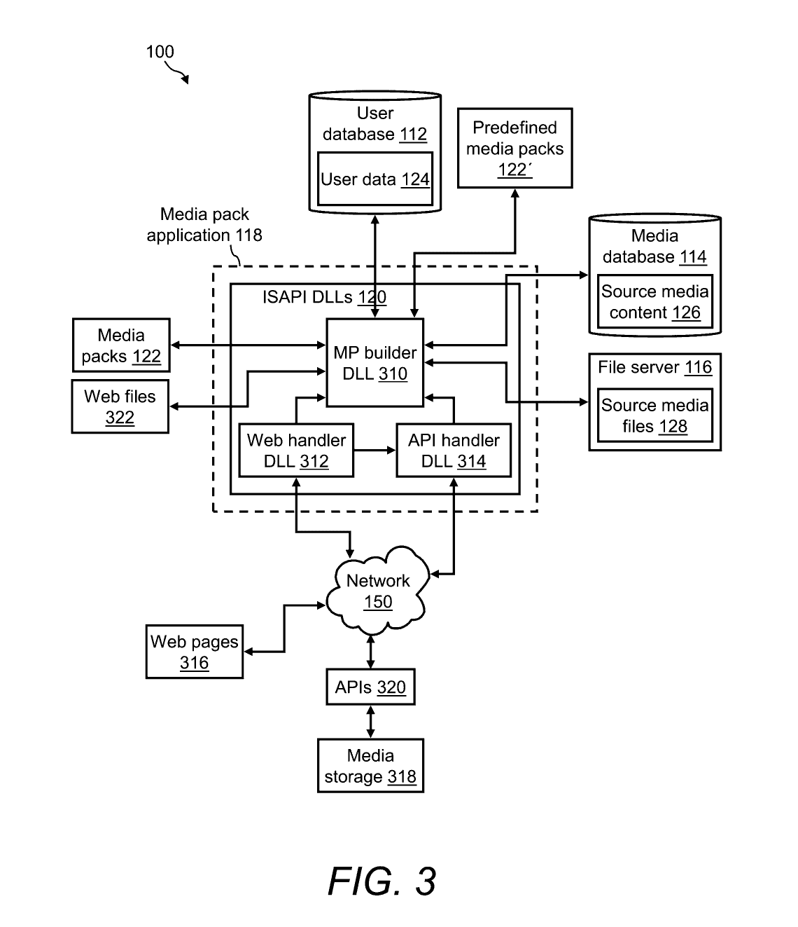

Referring now to FIG. 3 is a block diagram showing more details of media pack algorithm 118 of the presently disclosed secure digital asset distribution system 100. Namely, FIG. 3 shows that the set of ISAPI DLLs 120 of media pack algorithm 118 can include, for example, a media pack (MP) builder DLL 310, a web handler DLL 312, and an API handler DLL 314, which are arranged as shown. Web handler DLL 312 can be used to access web pages 316. Web handler DLL 312 may also be used to generate the Web GUI, handle the Login, user downloads, and/or other like functions. API handler DLL 314 can be used to access media storage 318 that is exposed to network 150 via APIs 320.

MP builder DLL 310 retrieves information. For example, the MP builder DLL 310 may query for the user data 124 stored in the user database 112, the source media content 126 stored by the media database 114, the source media files 128 stored in the file server 116, as well as the web files 322 and even predefined media packs 122. MP builder DLL 310 uses source media content 126, source media files 128, web pages 316, media storage 318, and/or predefined media packs 122 to create media packs 122 and web files 322. Once created, media packs 122 can be stored on media database 114 and/or file server 116.

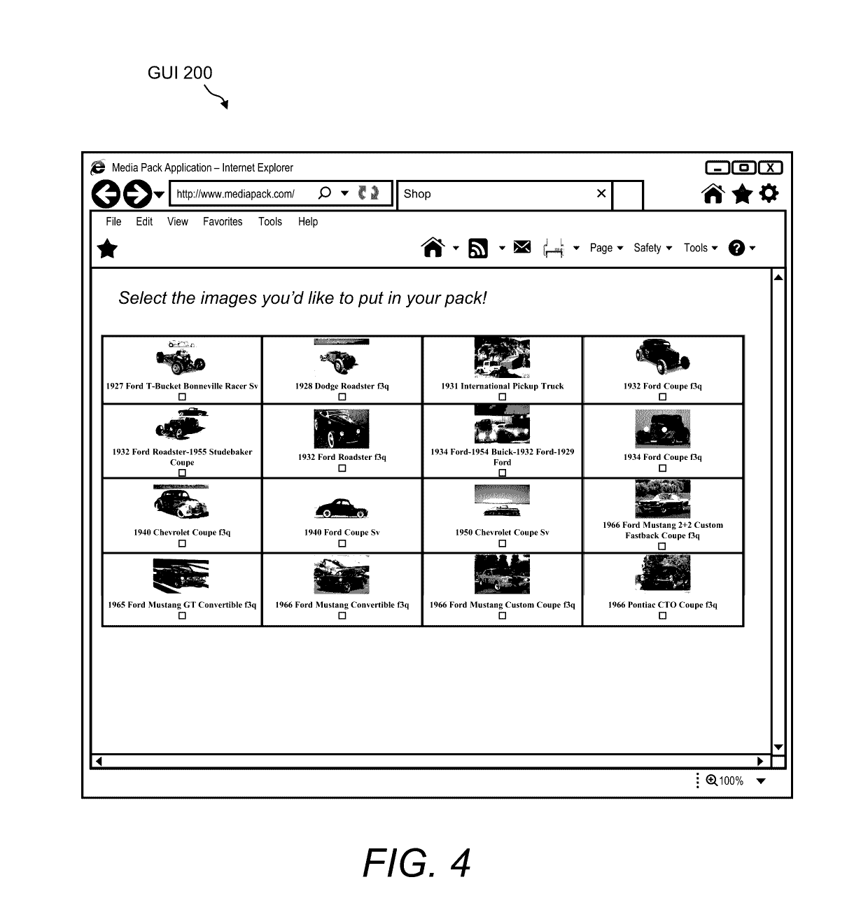

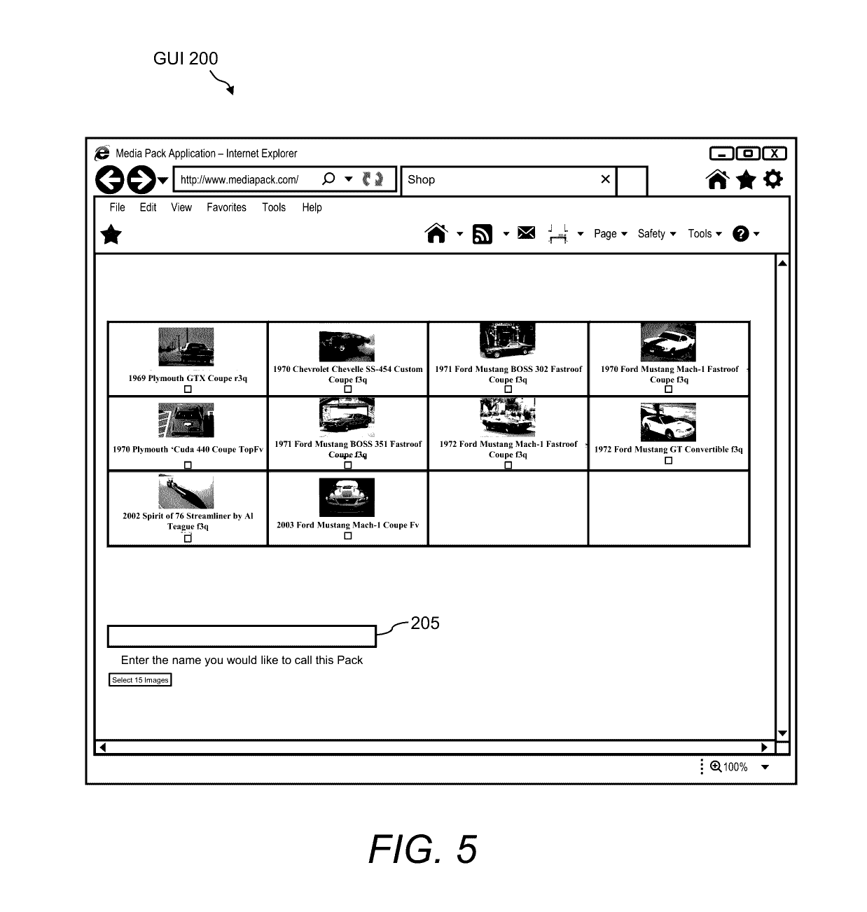

FIGS. 4 and 5 are screenshots of the GUI 200, according to exemplary embodiments. Here the GUI 200 is populated with examples of digital images from which the user (illustrated as reference numeral 105 in FIG. 1) may select to be included in the media pack 122 being created. For example, FIG. 4 displays images of vehicles of a certain year, vintage, or class, while FIG. 5 displays images of vehicles of a different year, vintage, or class. Optionally, the user 105 can purchase predefined media packs 122 from a similar page which shows thumbnail sized representations of the media within the media packs 122. For example, the media packs 122 shown in FIG. 2 may be an example of predefined media packs 122. At this step, the user 105 selects at least one digital asset they wish to package for their personal viewing (also, they can create multiple media packs 122). After completing the selections, the user 105 enters a name to use for the media pack(s) 122. For example, FIG. 5 shows a name entry field 205 at the bottom of GUI 200 for entering the name of the media pack 122.

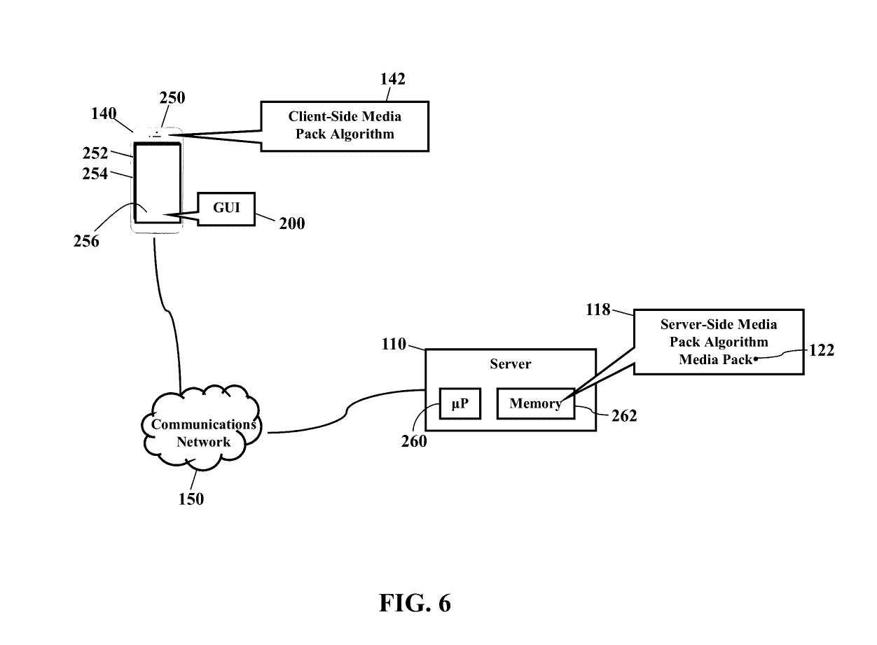

FIG. 6 is a more detailed illustration of the operating environment, according to exemplary embodiments. Here the server 110 and the user's computing device 140 may communicate via the communications network 150. For simplicity, the user's computing device 140 is illustrated as a mobile smartphone 250. As this disclosure explains, though, the user's computing device 140 may be any processor-controlled device (which later paragraphs will further explain). The mobile smartphone 250 has a processor 252 (e.g., “μP”), application specific integrated circuit (ASIC), or other component that executes the client-side media pack algorithm 142 stored in a local memory 254. The client-side media pack algorithm 142 may cause the processor 252 to generate the graphical user interface (“GUI”) 200 that is displayed on a display device 256 (such as a touch screen display common on many mobile devices). The server 110 may also have a processor 260 (e.g., “μP”), application specific integrated circuit (ASIC), or other component that executes the server-side media pack algorithm 118 stored in a local memory 262. The client-side media pack algorithm 142 and/or the server-side media pack algorithm 118 include instructions, code, and/or programs that may cooperate in a client-server relationship to generate the media pack 122. The client-side media pack algorithm 142 and/or the server-side media pack algorithm 118 may cause their respective processors 252 and 260 to performs operations or to instruct or cause another element to perform operations.

Exemplary embodiments may be applied regardless of networking environment. Exemplary embodiments may be easily adapted to stationary or mobile devices having cellular, wireless fidelity) (WI-FI®), near field, and/or BLUETOOTH® capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The respective processors 252 and 260 may be used in supporting a virtual processing environment. The respective processors 252 and 260 could include a state machine, application specific integrated circuit (ASIC), programmable gate array (PGA) including a Field PGA, or state machine. When any of the respective processors 252 and 260 execute instructions to perform “operations”, this could include performing the operations directly and/or facilitating, directing, or cooperating with another device or component to perform the operations.

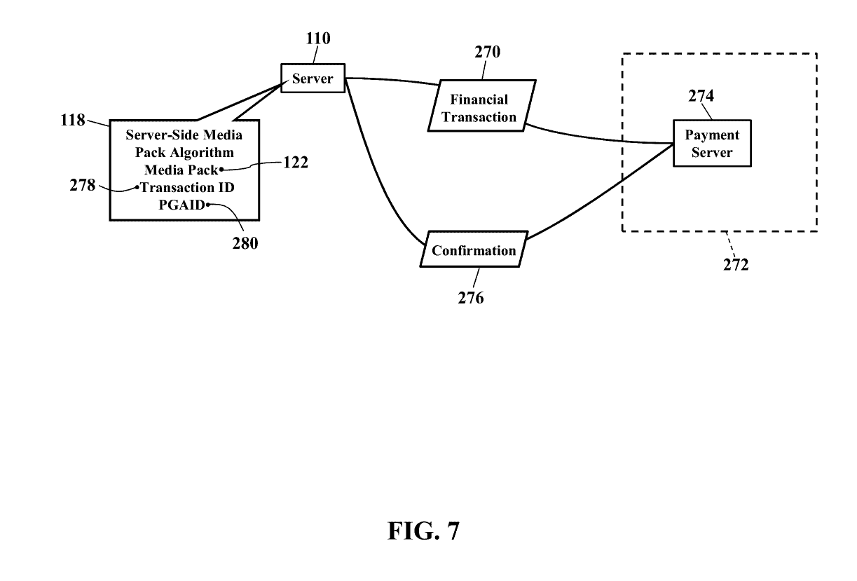

FIG. 7 illustrates payment processing, according to exemplary embodiments. A payment may be processed at any point during generation of the media pack 122. Some media packs 122 may be freely distributed, but most intellectual property rights owners will require financial compensation as consideration for use. Exemplary embodiments may thus process or participate in a financial transaction 270 using a credit card number, account number, or any other form of electronic payment. The server 110 may thus request or instruct a payment processor 272 (such as payment server 274) to conduct the financial transaction 270. Online financial transactions (such as credit card or PAYPAL® processing) are very well known, so this disclosure need not dwell on the details. In general, if the financial transaction 270 is approved, the server 110 receives a confirmation 276 of the financial transaction 270 from a payment processor. For example, the server 110 may receive a unique transaction identifier 278 having a data field containing a payment-gateway-assigned identification (or “PGAID”) 280 associated with the financial transaction 270. The PGAID 280 may be any combination of characters (alphanumeric, symbols, or the like) that is returned upon confirmation of the financial transaction 270.

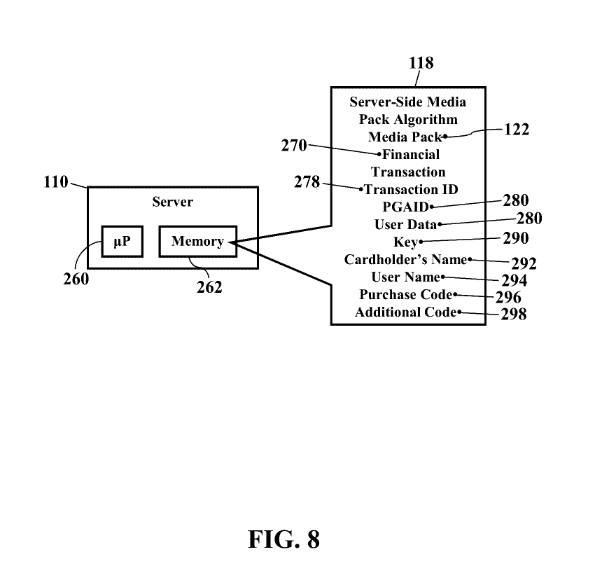

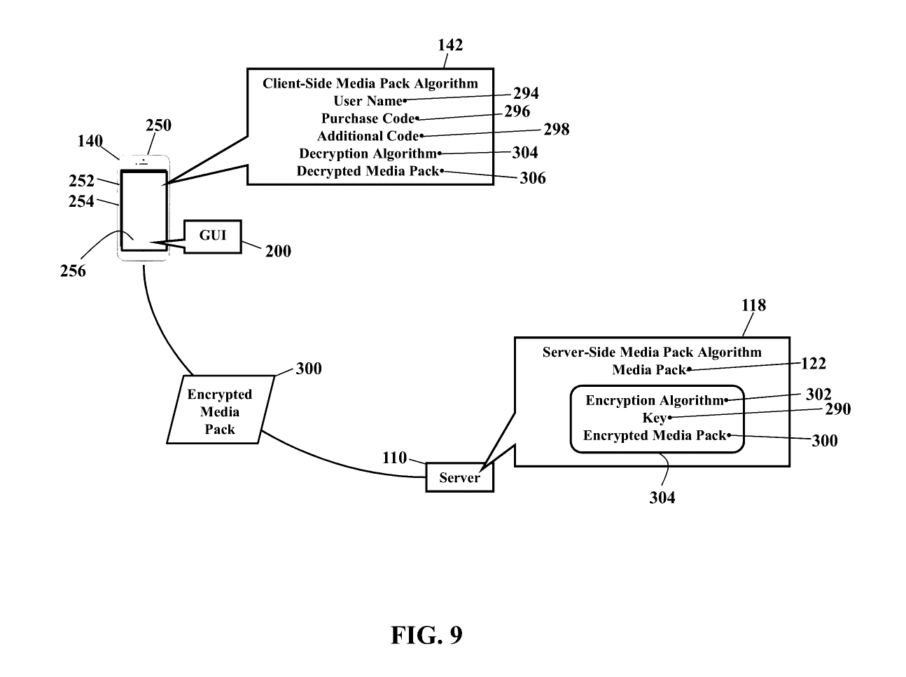

FIGS. 8-9 illustrate encryption of the media pack 122, according to exemplary embodiments. Once the financial transaction 270 is approved or verified, exemplary embodiments may encrypt the media pack 122 for secure distribution. The server-side media pack algorithm 118 may encrypt the assembled media pack 122 (and/or any of its individual file components) using the payment-gateway-assigned identification number (or “PGAID”) 280 and/or the user data 124 retrieved from the electronic user database (illustrated as reference numeral 112 in FIG. 1). The server-side media pack algorithm 118, for example, may generate a key 290 using characters obtained from the PGAID 280. The key 290 may also use characters obtained from a cardholder's name 292 (e.g., first and last), which is also returned from the payment processor (illustrated as reference numeral 272 in FIG. 7).

Exemplary embodiments may also use other characters to generate the key 290. Once the server-side media pack algorithm 118 receives the PGAID 280 and the cardholder's name 292, the server-side media pack algorithm 118 may generate additional character strings. The server-side media pack algorithm 118 may generate a unique user name 294, a unique purchase code 296, and/or a unique additional code 298. For example, the server-side media pack algorithm 118 may randomly select any one or more individual characters contained within the PGAID 280 to form the unique user name 294. The characters contained within the unique purchase code 296 and the unique additional code 298 may also be randomly chosen from the PGAID 280. Assume, for example, that the PGAID 280 contains twenty three (23) alphanumeric characters. The server-side media pack algorithm 118 may select any character from any position (including hyphens) to generate the unique user name 294, the unique purchase code 296, and/or the unique additional code 298. Exemplary embodiments, however, may alternatively or additionally define specific character spaces of the PGAID 280 to define the unique user name 294, the unique purchase code 296, and/or the unique additional code 298.

The key 290 is thus unique to each user 105. For example, assume the key 290 is selected using the PGAID 280, the cardholder's name 292, and the unique purchase code 296 (selected from the PGAID 280). Even if two (2) different users have identical cardholder's names 292, their respective keys 290 would still be unique (simply based on their different PGAIDs 280).

FIG. 9 illustrates an encrypted media pack 300, according to exemplary embodiments. Once the key 290 is determined, the server-side media pack algorithm 118 passes or sends the unique key 290 to an encryption algorithm 302. FIG. 9, for simplicity, illustrates the encryption algorithm 302 as a sub-module 304 of the server-side media pack algorithm 118. There are many known encryption algorithms that may utilize the key 290 to encrypt the media pack 122, so no further explanation is necessary. The encryption algorithm 302 uses the key 290 to generate the encrypted media pack 300. The server-side media pack algorithm 118 then instructs the server 110 to invoke its network interface to send the encrypted media pack 300 to the network address associated with the mobile smartphone 250. The encrypted media pack 300 may be sent and received as packets of data according to a packet protocol (such as any of the Internet Protocols). The packets of data contain bits or bytes of data describing the contents, or payload, of messages representing the encrypted media pack 300. A header of each packet of data may contain routing information identifying an origination address and/or a destination address.

Decryption may then be performed. When the mobile smartphone 250 receives the encrypted media pack 300, the user 105 usually wishes to access or view its contents. The user 105 must authenticate with the client-side media pack algorithm 142 to open the encrypted media pack 300. Here, though, the user 105 must authenticate with the same information used to generate the key 290. That is, the user 105 must enter the unique user name 294, the unique purchase code 296, and the unique additional code 298 originally selected from the PGAID 280 generated during the initial financial transaction 270. If the user 105 successfully authenticates, the client-side media pack algorithm 142 invokes or calls a decryption algorithm 304. The decryption algorithm 304 utilizes the unique user name 294, the unique purchase code 296, and the unique additional code 298 to decrypt the media pack 122. A decrypted media pack 306 is thus generated. Once decryption is complete, the client-side media pack algorithm 142 may access the digital contents contained within the decrypted media pack 306.

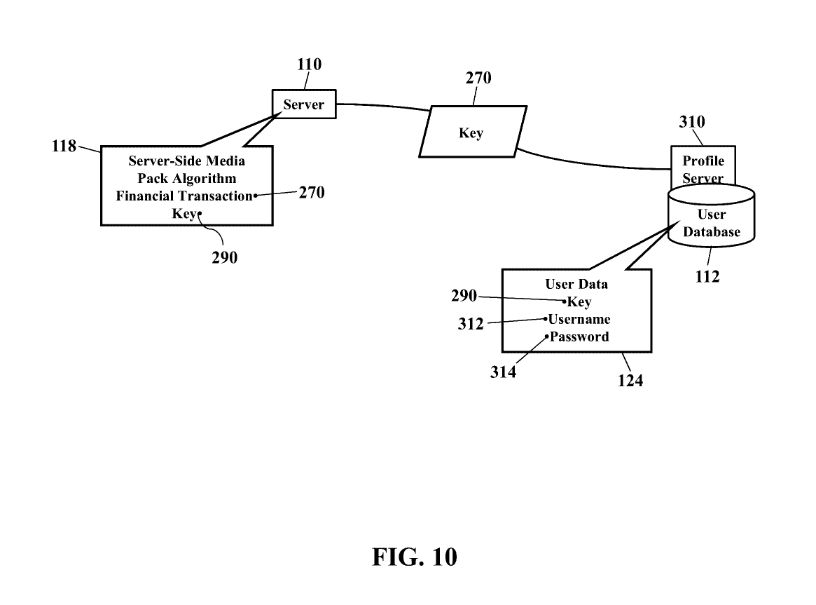

FIG. 10 illustrates profile storage, according to exemplary embodiments. Once the key 290 is generated, exemplary embodiments may retain the key 290 for future use. FIG. 10, for example, illustrates the server 110 sending the key 290 to the network address associated with a profile server 310 storing the electronic user database 112. The key 290 may thus be added to a user profile associated with the corresponding user. Exemplary embodiments may thus add a database entry that electronically associates the key 290 to other values or fields in the user data 124. So, whenever the same user again authenticates (perhaps using a username 312 and password 314), exemplary embodiments may retrieve the key 290 when generating future media packs. In other words, future purchases by the same user (e.g., authenticating using the username 312 and password 314) may also be encrypted using the key 290 derived or created during the initial financial transaction 270.

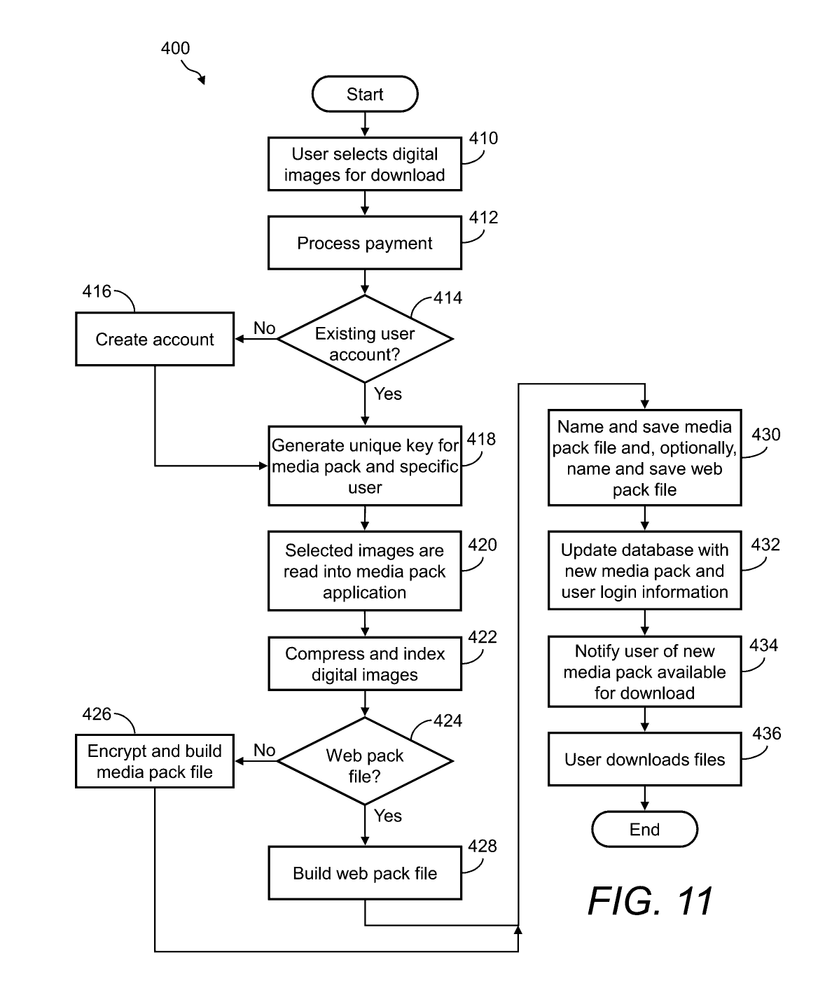

FIG. 11 illustrates a flow diagram of an exemplary method or algorithm for creating the encrypted media pack 300, according to exemplary embodiments. The method or algorithm may include, but is not limited to, the following steps. At a step 410, the user 105 selects one or more digital images for download. For example, the user 105 selects at least one digital image that they wish to package for their personal viewing. Further, the user 105 can make selections to create one or multiple media packs 122. At a step 412, after selections have been made, the user 105 is directed to the payment processing operations of secure digital asset distribution system 100. Method 400 proceeds to step 414. At a decision step 414, at payment processing, the user 105 will be checked for a user account. In this step, it is determined whether the user 105 is an existing user with an existing account on secure digital asset distribution system 100 or a new user that does not have an account. If a new user 105, then method 400 proceeds to step 416. However, if an existing user 105, then method 400 proceeds to step 418.

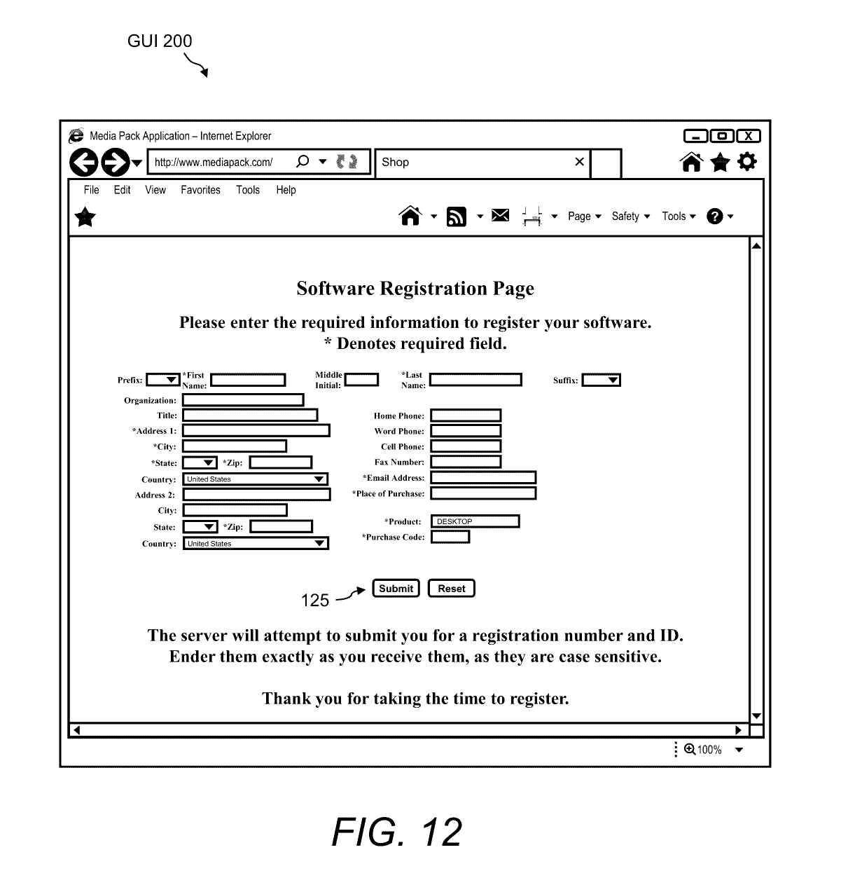

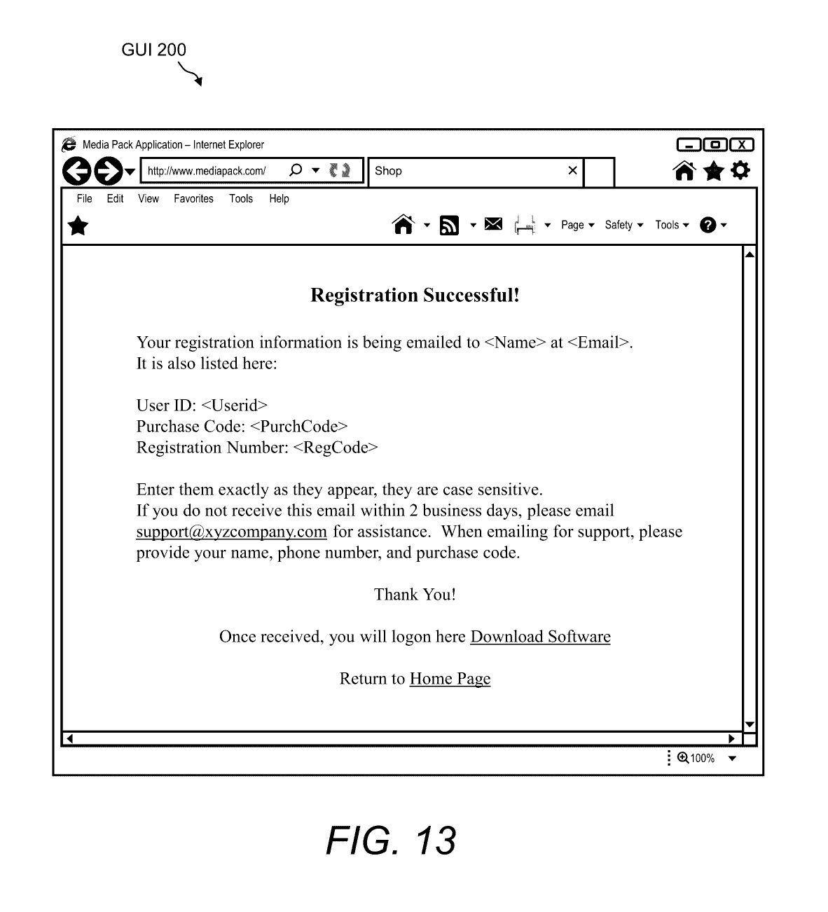

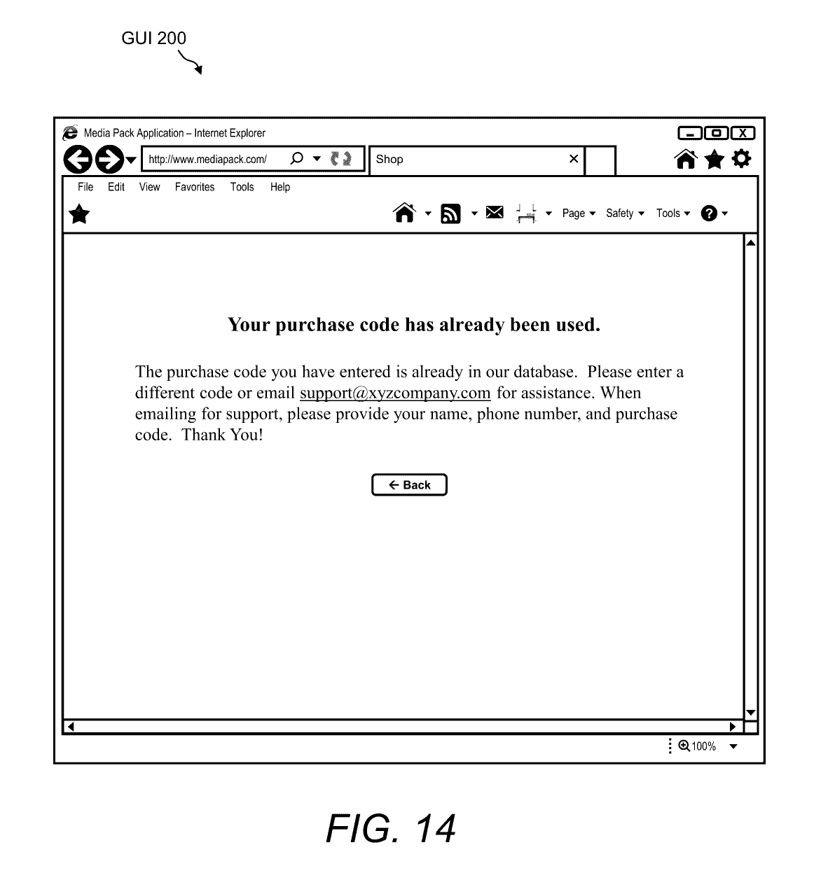

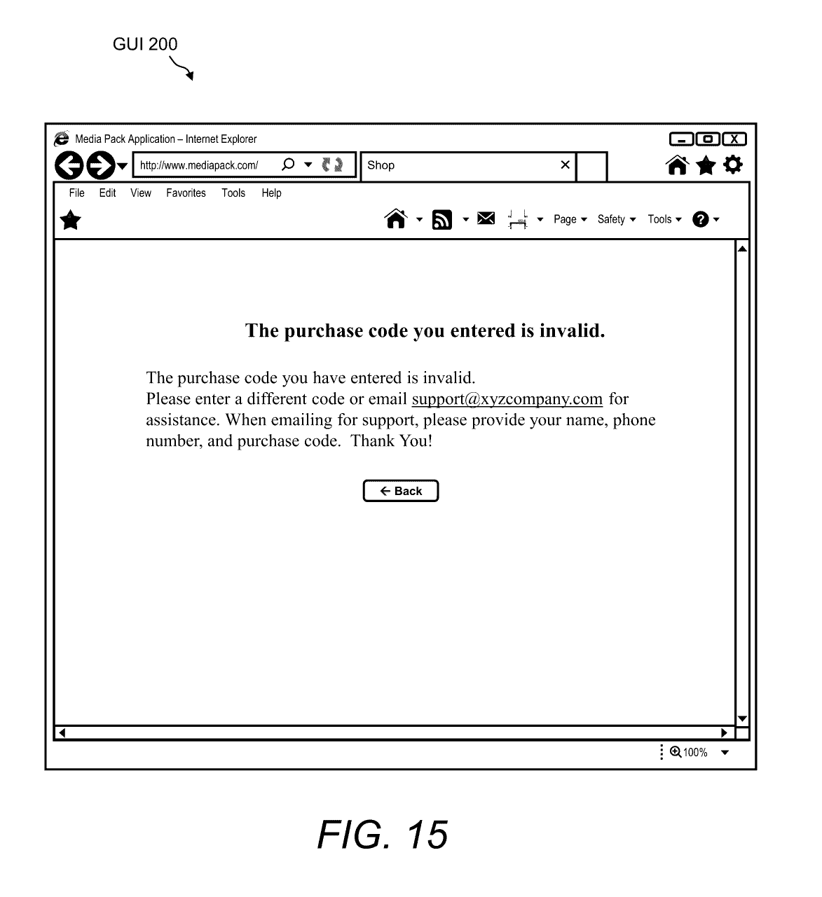

At a step 416, an account is created for the new user 105. (FIGS. 12-13 illustrate further screenshots of the GUI 200, which are examples of the screens used to set up a new account.) At a step 418, the key 290 is generated for the media pack 122 and the specific user 105, which will be used to build the encrypted media pack 300. At this step, one of two error messages may be displayed, as shown in FIGS. 14 and 15. Once the payment process is confirmed (as explained with reference to FIG. 7), exemplary embodiments receive the payment confirmation 276 and process the user's request. At a step 420, the selected digital images are read into media pack algorithm 118. At a step 422, media pack algorithm 118 indexes and compresses (e.g., using standard compression routines, such as gzip, 7z, lzw, lha, zip) the selected digital images into a single proprietary file. At a decision step 424, it is determined whether there will be a web pack file. If no, then method 400 proceeds to step 426. If yes, then method 400 proceeds to step 428.

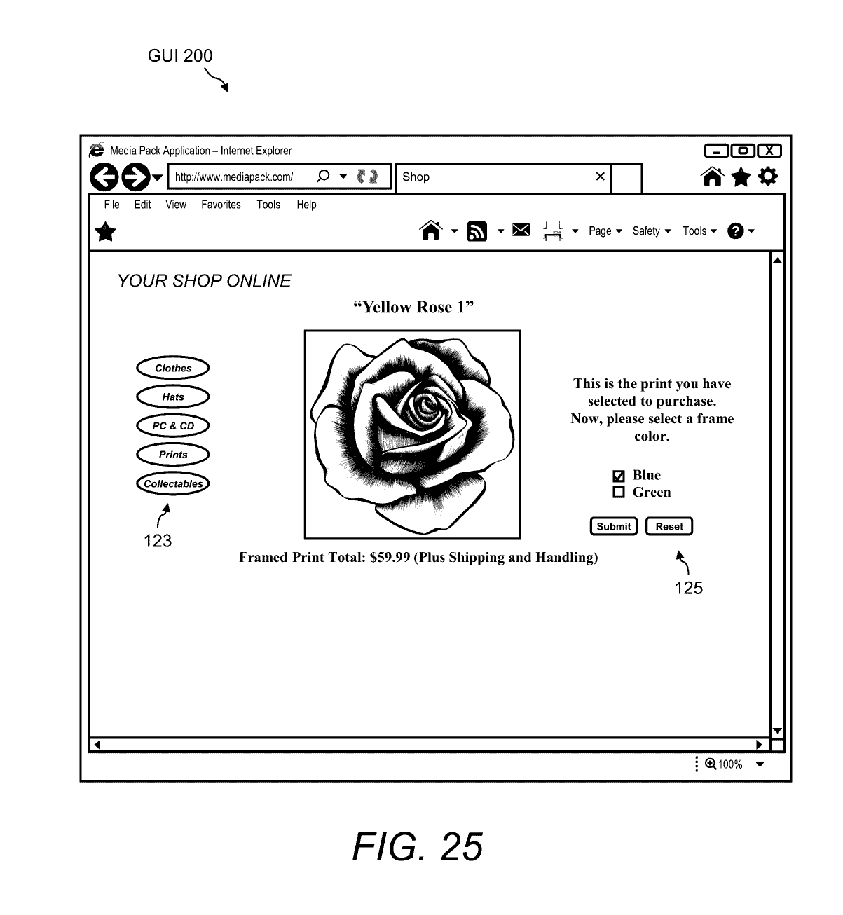

At step 426, the media pack file is encrypted and built. For example, the payment-gateway-assigned identification number 280 may be used to create the key 290 to the file (and uses the same the key 290 for all of that specific user 105's media packs 122 going forward) to encrypt (e.g., using standard encryption-DES, RSA, Twofish) the file for deployment to the user 105. At a step 428, the web pack file is built. If the user 105 has selected media that has a “Click to Buy” feature, a secondary file is created for deployment. This secondary file contains the URL/URI (Uniform Resource Locator/Uniform Resource Identifier) for the user 105 to land on to purchase a physical copy/physical rights to the specific content of the media pack 122. The contents of this file are indexed to the contents of the media pack 122. For example, if within the media pack 122, image #3 is an image of a yellow flower (see FIG. 25), the URL may launch the user 105 (when clicked) to a URL/URI specifically designed to allow the user 105 to utilize that yellow flower in any desired manner. For example, the URL/URI allows the user 105 to purchase a print of the yellow flower, license the digital rights to the yellow flower, purchase a coaster with the yellow flower on it, purchase a mouse pad with the yellow flower on it, and/or other similar type item.

At a step 430, the media pack 122 is named and saved and, optionally, the web pack file is named and saved. At a step 432, the media database 114 is updated with the new media pack 122 and the user login information. At a step 434, the user 105 is notified that the new media pack 122 is available for download. For example, once the media pack 122 and any associated files are built, media pack algorithm 118 transmits a notification (e.g., email or text) to the user 105 that the media pack 122 is ready for download. At a step 436, using the media pack algorithm 142 on his/her personal computing device 140, the user 105 logs in per the GUI 200 shown in FIG. 12, and then downloads the media pack 122. For example, the user 105 logs into media pack algorithm 118 and retrieves their media pack 122. FIG. 15 shows GUI 200 and an example of a login screen. The user can download the media pack 122 to any one or more of their personal computing devices 140 to view the digital media in the media pack 122.

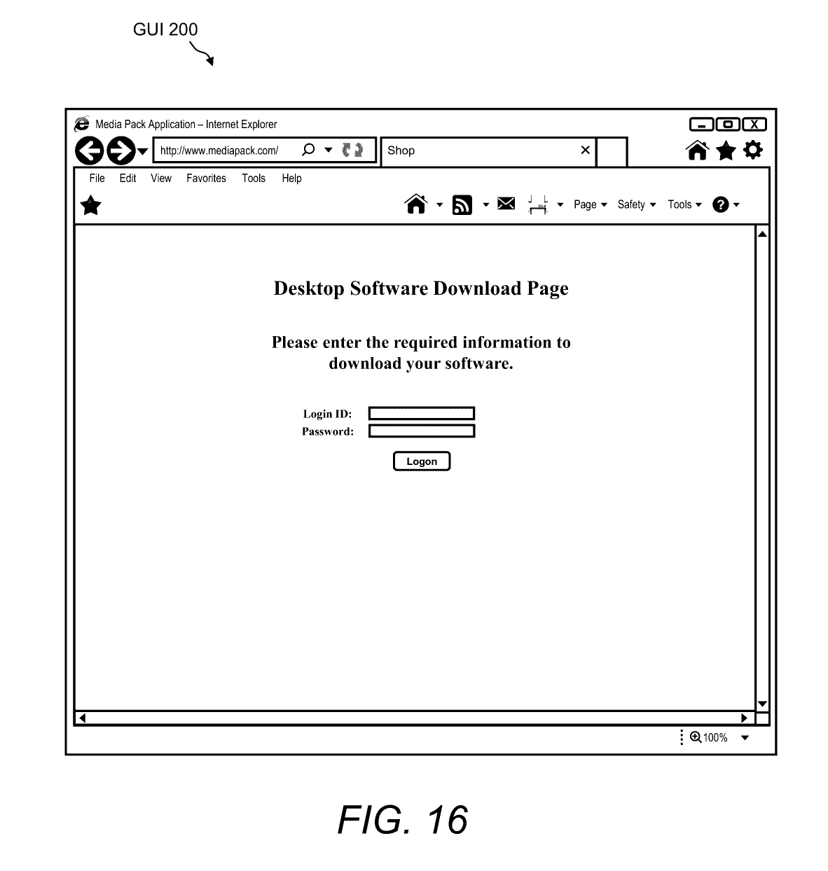

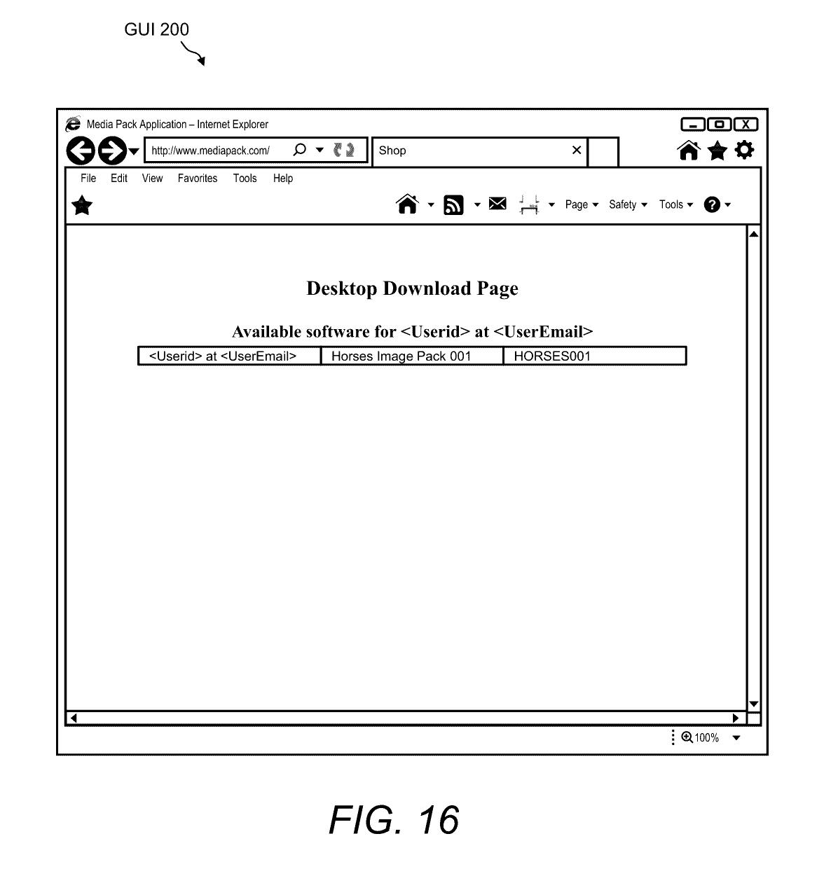

For all types of personal computing devices 140, the user 105 can download media pack algorithm 142, which is distributed software, from a website. For example, FIG. 16 shows a view of GUI 200, which is, for example, an internet browser at a web address for downloading media pack algorithm 142.

In the presently disclosed secure digital asset distribution system 100 and method 400, each media pack 122, which can be a photo packet, is encrypted and keyed to a specific user 105's personal account per the user 105′s user data 124, wherein the user 105 is registered and/or subscribed to the system. Consequently, if a user 105 tries to transfer the media pack to someone else's device, the someone else's media pack algorithm 142 will not be able to decrypt the media pack 122 and therefore would be unable to use the digital media. Accordingly, the presently disclosed secure digital asset distribution system 100 and method 400 allow owners, creators, and/or publishers of digital media to control the use of the digital media even after sent to a user. Namely, the digital media may be limited to use, for example, only as “wallpaper” and/or “screensaver” and viewed by the registered user using the media pack algorithm. For example, due to the processing of the media pack 122, John Doe will only be able to open media packs 122 that John Doe purchases. If John Doe transfers a media pack 122 to Jane Smith, the media pack 122 will not open. This is due to the nature of the encrypting of the specific media pack 122 when it was purchased by John Doe. Each user's “key” to the encryption is to that registered user only. Registration information within media pack algorithm 142 is static.

### Personal Computers

With respect to personal computers (e.g., desktop and laptop computers), media pack algorithm 142 is a desktop application that can be used by users 105 to access the media pack 122 for display of the digital media contained on the “desktop” in the form of “wallpaper.” Further, media pack algorithm 142 can be used to access the media pack 122 and then display the digital media contained on the screen in the format of a “screen saver” (if supported). Media pack algorithm 142 may also include viewer software that allows users 105 to view the digital media contained in the media packs 122.

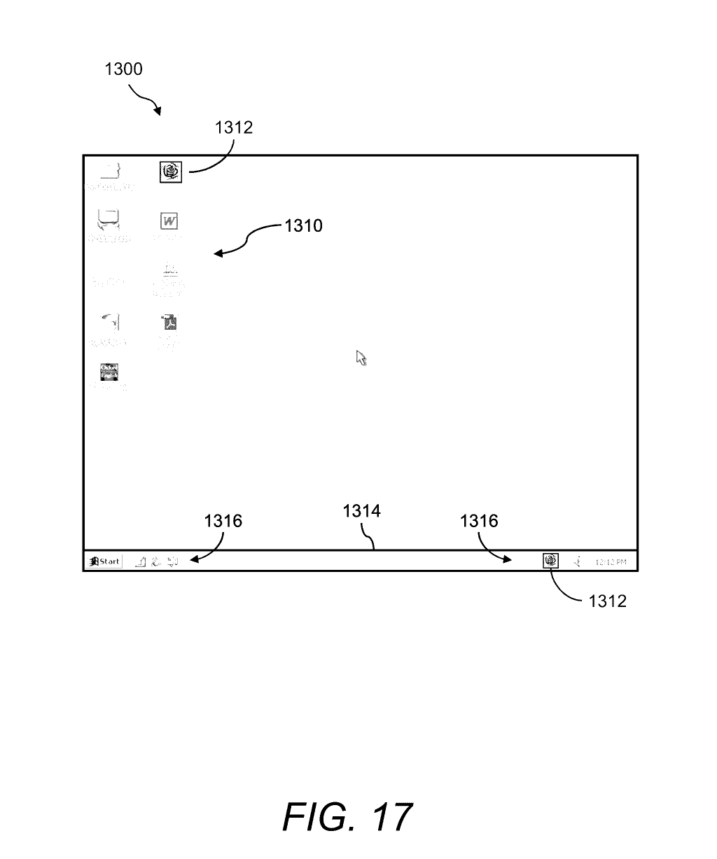

For example, the portion of media pack algorithm 142 that runs for displaying wallpaper functions as follows. For each personal computing device 140, the user 105 starts media pack algorithm 142. For example, FIG. 17 shows a Windows desktop 1300 on which there is a set of desktop icons 1310. One of the desktop icons 1310 is a media pack icon 1312 for launching media pack algorithm 142. Windows desktop 1300 also includes a taskbar 1314. Taskbar 1314 may include a set of taskbar icons 1316.

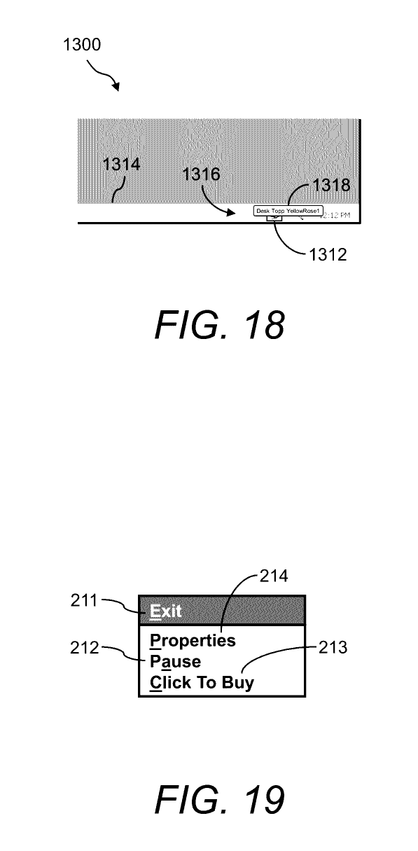

On personal computers, when the user selects the media pack icon 1312 and starts media pack algorithm 142, media pack algorithm 142 displays a splash screen (not shown). The splash screen can show, for example, media pack icon 1312, notifying users that media pack algorithm 142 is starting. This is a standard function for most applications. At this point, the splash screen closes automatically and media pack algorithm 142 and media pack icon 1312 is placed in taskbar 1314 at the bottom of the screen. Another view of taskbar 1314 with media pack icon 1312 is shown in FIG. 18. User 105 can hover the cursor over media pack icon 1312 in taskbar 1314 for a description (e.g., see popup 1318 in FIG. 18) of the digital media currently displayed.

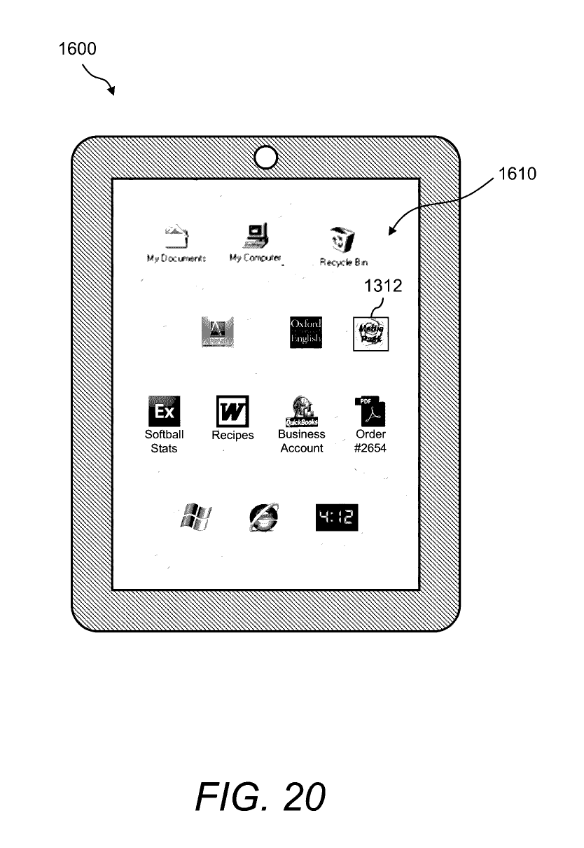

In another example, FIG. 20 shows an example of a tablet device desktop 1600 on which there is a set of desktop icons 1610. Again, one of the desktop icons 1610 is media pack icon 1312 for launching media pack algorithm 142.

Referring now again to FIGS. 17-19, default settings are used on the first run. If user 105 clicks on media pack icon 1312 in taskbar 1314, the next digital media is shown from the open media pack 122. User 105 can “right click” media pack icon 1312 in taskbar 1314 to access a menu of items, as shown in FIG. 19. This is also how user 105 changes the settings of media pack algorithm 142. For example, if user 105 clicks “exit” 211, media pack algorithm 142 terminates and restores the computer desktop back to what it was prior to running media pack algorithm 142. User 105 can click “Pause” 212 to keep the currently displayed digital media displayed on the desktop until user 105 cancels the pause by clicking it again. With certain media packs 122, user 105 will be able to use the “Click to Buy” 213 and that feature will also be in this menu, allowing user 105 to launch their default internet browser to a web page associated with that specific digital asset for sale in whichever form the publisher wishes (secondary file created in step 428 illustrated in FIG. 11). User 105 can also launch the settings of the program by clicking “properties” 214. The popup menu selections are not all inclusive and may have additions or subtractions of options.

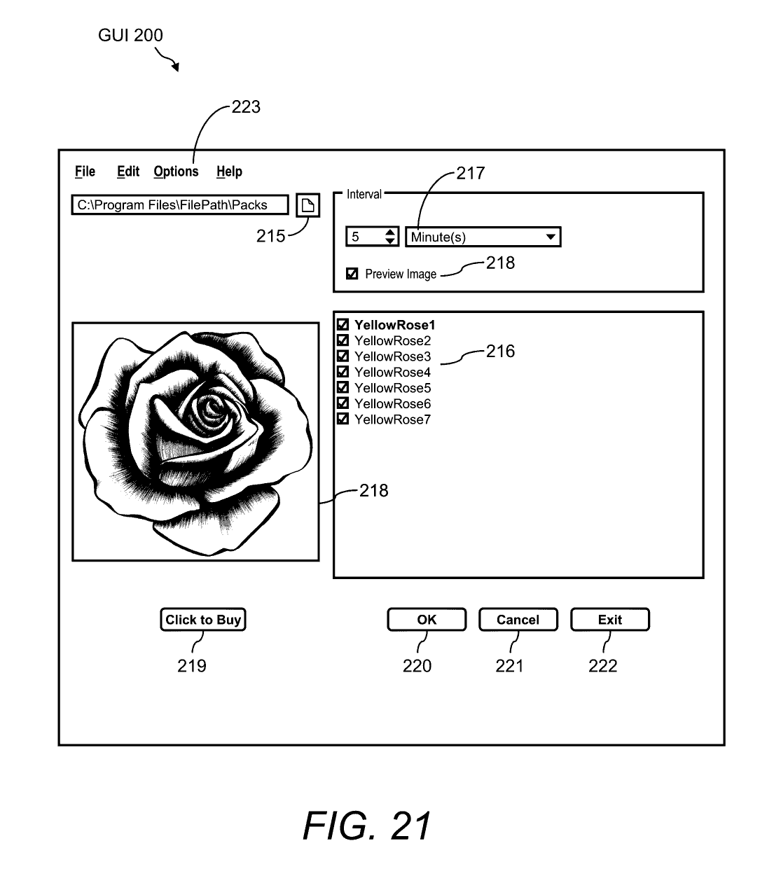

If the user clicks “properties” 214, a screen is launched giving the user access to the settings, an example of which is shown in GUI 200 in FIG. 21. These settings include but are not limited to opening another media pack 122 using a button 215, selecting/deselecting digital media 216 to be shown/not shown, changing the media rotation rate (e.g., how many minutes/seconds does the user want the next digital media from the media pack 122 shown) using dropdown menu 217, whether media pack algorithm 142 starts when the operating system starts or not, icon options of the desktop (for example MICROSOFT WINDOWS® icons can be made to be more transparent for optimal media viewing), whether the user wants to preview the digital media contained in the currently open media pack 122 and a preview window 218 of selected media, a “Click to Buy” button 219 if the current media pack 122 supports it, a save button 220 to save changes and close the settings, a cancel button 221 to cancel changes and close the settings, an exit button 222 to exit the entire program, a menu bar 223 with various options previously mentioned along with the ability to enter registration information, display help, and to display information about the program such as copyright, trademarks, patent information, and so on.

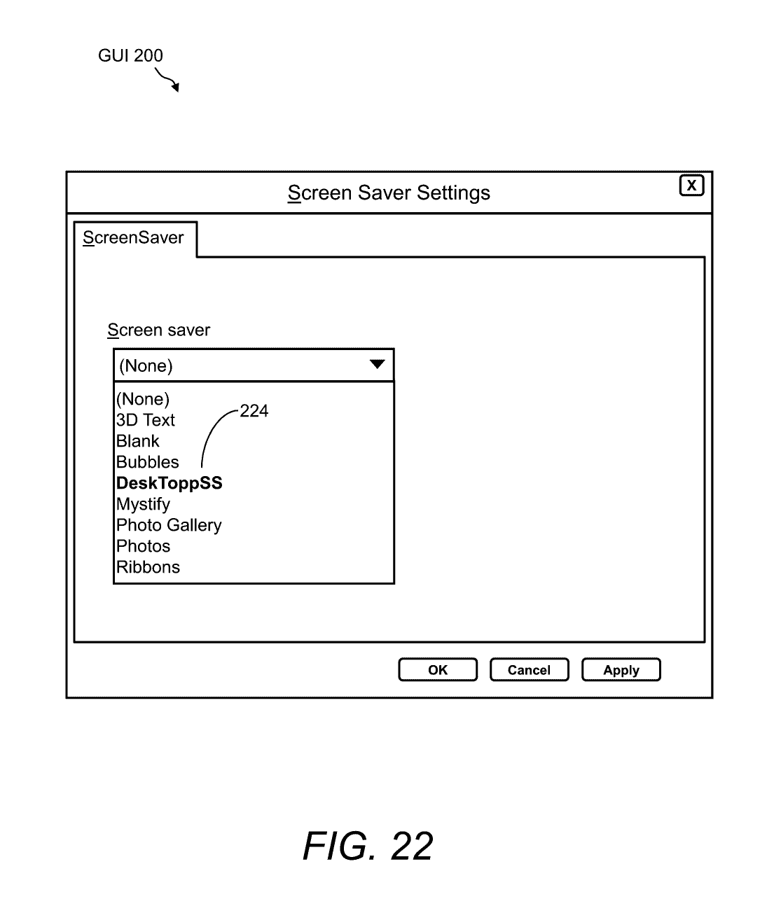

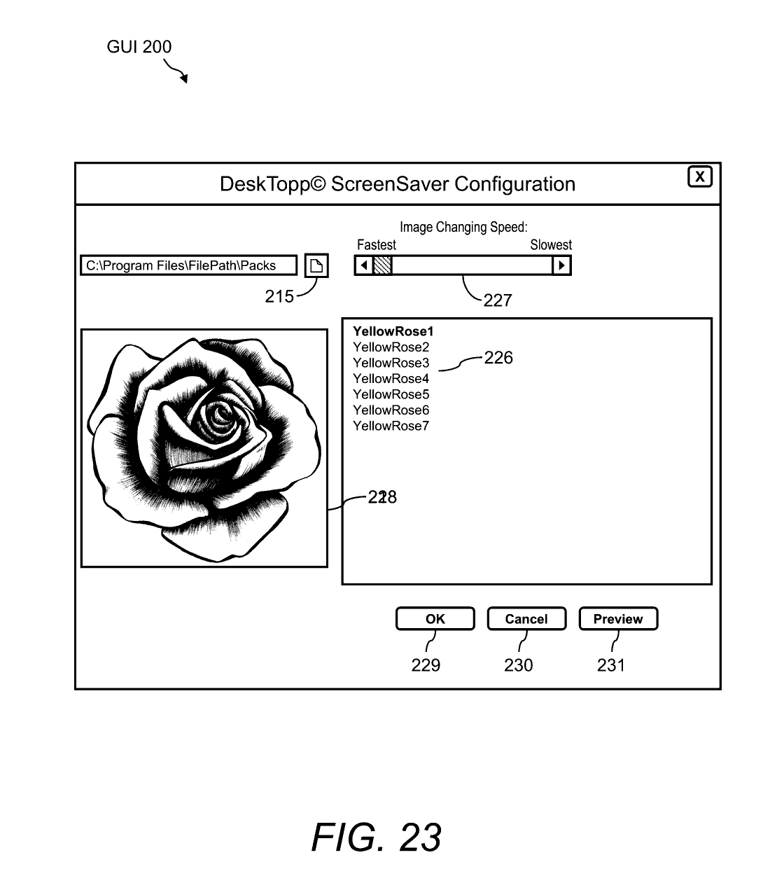

The screen saver portion of media pack algorithm 142 shall incorporate into the operating system's standard handler for screen savers. For example, the screen saver portion of media pack algorithm 142 may incorporate into the operating system's screensaver options screen shown in FIG. 22 with the name, for example, of “DesktoppSS” 224. Selecting the screen saver and clicking the “settings” button launches the settings for the screen saver, an example of which is shown in FIG. 23. Referring now to FIG. 23, these settings include, but are not limited to, button 215 for opening another media pack 122, selecting/deselecting digital media 226 to be shown/not shown, changing the media rotation rate (how many minutes/seconds does the user want the next digital media from the media pack 122 shown) using slider bar 227, a preview window 228 to preview the digital media contained in the currently open media pack 122, a save button 229 to save changes and close the settings, a cancel button 230 to cancel changes and close the settings, and a preview button 231 to launch a preview in the preview window 228 of the selected screen saver.

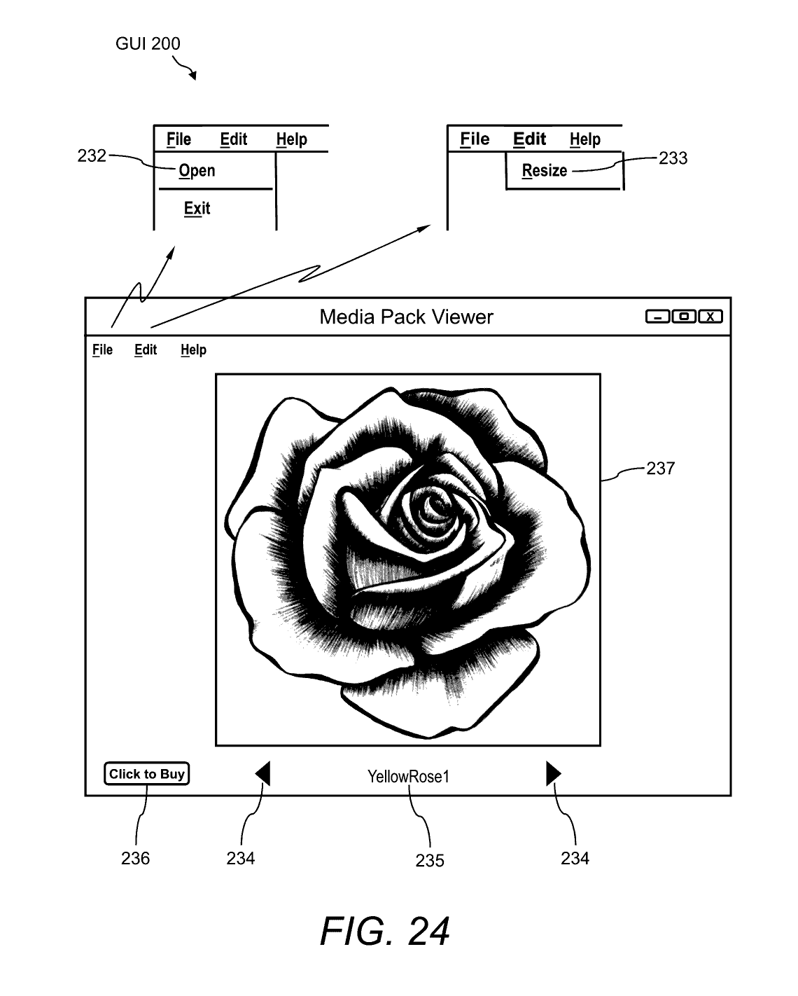

For personal computers, the viewer portion of media pack algorithm 142 launches and allows the user to view the digital media in the media packs 122 on screen, an example of which is shown in FIG. 24. The features include, but are not limited to, an open button 232 to change media packs 122, a viewing window 237 to view the selected digital media within the screen size of the application as well as switch (resize option 233) to the full size view of the media and back again, and scroll controls 234 for scrolling thru the media contained in the selected media pack 122, a name display 235 of the name of the selected media, and a “Click to Buy” button 236 if the current media pack 122 supports it.

### Mobile Devices

With respect to Apple iPhones and iPads and Android devices, media pack algorithm 142 is a mobile app that can be used by users 105 to access a media pack 122 for display of the digital media contained on the screen in the form of “wallpaper”/“live wallpaper.” Media pack algorithm 142 may also include viewer software that allows users 105 to view the digital media contained in the media packs 122.

For mobile devices, media pack algorithm 142 can be available via the login website (see FIG. 16) and/or through the appropriate “app store” (e.g., Google Apps, and the like). Media packs 122 purchased will be available for download via the login website (see FIG. 16), as well as transferred between the same user 105's personal computing devices. That is, the purchase media packs 122 can be used on any or all of the user 105's personal computing devices.

Media pack algorithm 142 for mobile devices to set the wallpaper on the device may have a similar look and feel as the personal computer version. User 105 launches media pack algorithm 142 on their device. Then, a display will appear, giving user 105 the ability to set the app's settings. These settings may include, but are not limited to, opening another media pack 122, selecting/deselecting digital media to be shown/not shown, changing the media rotation rate (how many minutes/seconds does the user want the next digital media from the media pack 122 shown), whether media pack algorithm 142 starts when the operating system starts or not, whether user 105 wants to preview the digital media contained in the currently open media pack 122, whether user 105 wants to select/deselect from a displayed list media they wish to display or not display, a “Click to Buy” button if the current media pack 122 supports it, a button to save changes and close the settings, a button to cancel changes and close the settings, and a button to exit the entire app.

For mobile devices, the viewer portion of media pack algorithm 142 launches and allows user 105 to view the digital media in the media packs 122 on screen in the application. The viewer provides users the ability to change media packs 122, and scroll thru the media contained in the selected media pack 122.

In other embodiments, media pack algorithm 142 for personal computers and/or mobile devices supports live wallpaper. For example, user 105 launches media pack algorithm 142 on their device. Then, a display appears giving user 105 the ability to set the app's settings. These settings may include, but are not limited to, opening another media pack 122, selecting/deselecting digital media to be shown/not shown, changing the media rotation rate (how many minutes/seconds does the user want the next digital media from the media pack 122 shown), whether media pack algorithm 142 starts when the operating system starts or not, whether user 105 wants to preview the digital media contained in the currently open media pack 122, whether user 105 wants to select/deselect from a displayed list media they wish to display or not display, a “Click to Buy” button if the current media pack 122 supports it, a button to save changes and close the settings, a button to cancel changes and close the settings, and a button to exit the entire app.

### Media Pack

The presently disclosed secure digital asset distribution system 100 focuses around one specific item—the media pack 122. This media “pack” (package) is a proprietary file type, consisting of one or more digital assets (e.g., digital images, video, music), which is then encrypted with a key that allows only that specific registered user to open, decrypt, and view the digital assets in a specific, authorized way, such as a “wallpaper,” “screensaver,” or through the use of the viewer software.

### Click to Buy

Anytime a user 105 clicks the “Click to Buy” button, their default Internet browser will open to the webpage that corresponds to the specific media being displayed or viewed at the time of the click, an example of which is shown in FIG. 25. This page will have options including, but not limited to, purchasing a physical representation of the media, options for size/shape of that physical representation, options for framing/borders of the physical media, the option to license/lease a digital representation of the media, options for licensing/leasing various sizes and formats of a digital representation of that media, as well as standard payment functionality.

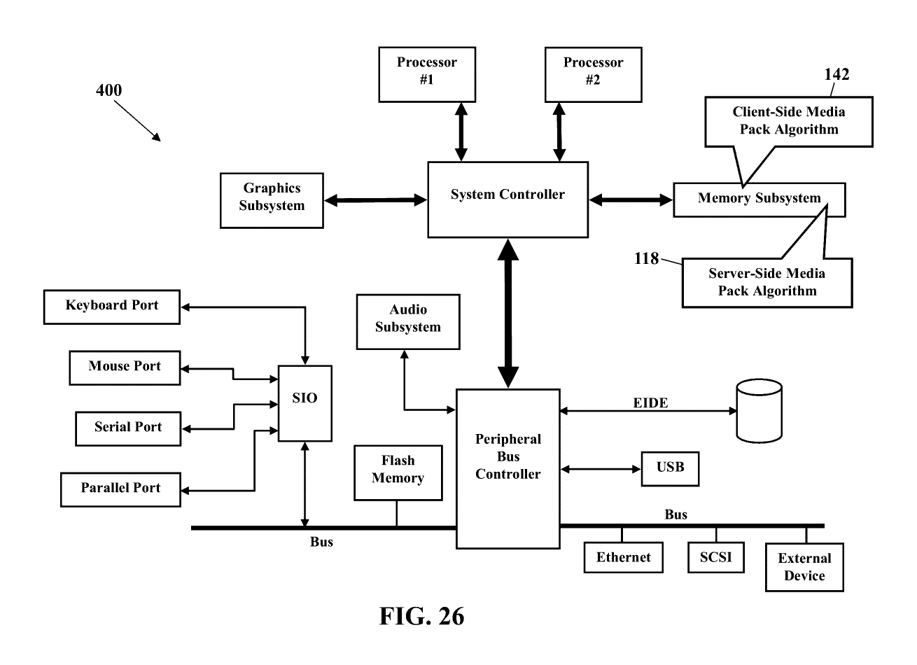

FIG. 26 is a schematic illustrating still more exemplary embodiments. FIG. 26 is a more detailed diagram illustrating a processor-controlled device 400. As earlier paragraphs explained, the client-side media pack algorithm 142 and/or the server-side media pack algorithm 118 may partially or entirely operate in any mobile or stationary processor-controlled device. FIG. 26, then, illustrates the client-side media pack algorithm 142 and/or the server-side media pack algorithm 118 stored in a memory subsystem of the processor-controlled device 400. One or more processors communicate with the memory subsystem and execute either, some, or all applications. Because the processor-controlled device 400 is well known to those of ordinary skill in the art, no further explanation is needed.

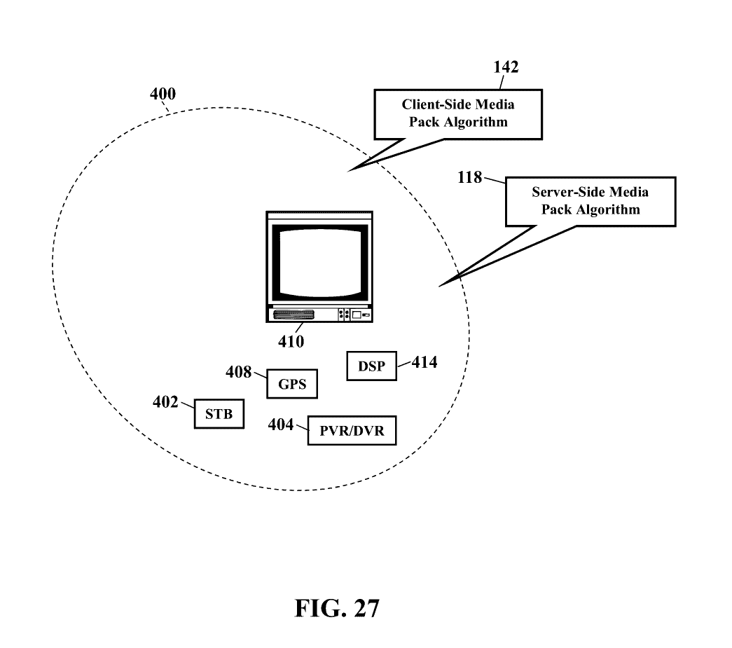

FIG. 27 depicts other possible operating environments for additional aspects of the exemplary embodiments. FIG. 27 illustrates the client-side media pack algorithm 142 and/or the server-side media pack algorithm 118 operating within various other processor-controlled devices 400. FIG. 27, for example, illustrates that the client-side media pack algorithm 142 and/or the server-side media pack algorithm 118 may entirely or partially operate within a set-top box (“STB”) (402), a personal/digital video recorder (PVR/DVR) 404, a Global Positioning System (GPS) device 408, an interactive television 410, or any computer system, communications device, or processor-controlled device utilizing any of the processors above described and/or a digital signal processor (DP/DSP) 414. Moreover, the processor-controlled device 400 may also include wearable devices (such as watches), radios, vehicle electronics, clocks, printers, gateways, mobile/implantable medical devices, and other apparatuses and systems. Because the architecture and operating principles of the various devices 400 are well known, the hardware and software componentry of the various devices 400 are not further shown and described.

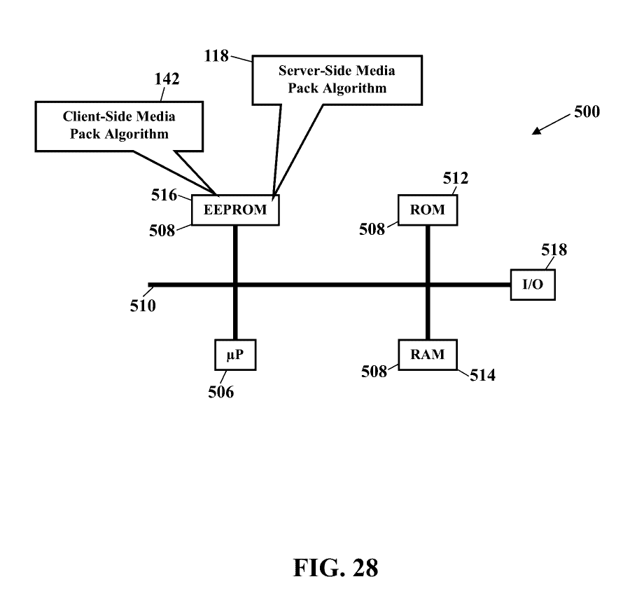

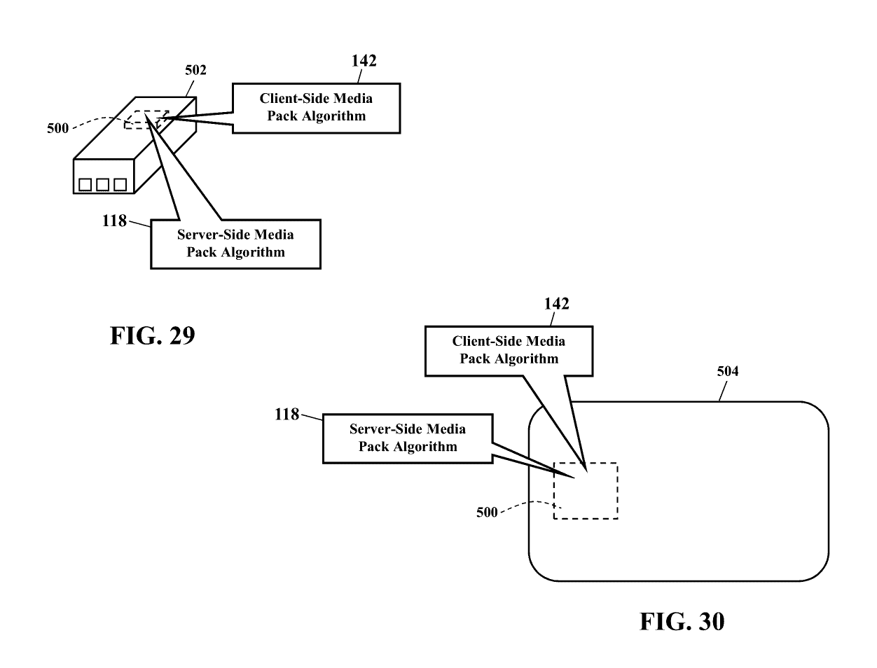

FIGS. 28-31 are schematics further illustrating operating environments for additional aspects of the exemplary embodiments. FIG. 28 is a block diagram of a Subscriber Identity Module 500, while FIGS. 29 and 30 illustrate, respectively, the Subscriber Identity Module 500 embodied in a plug 502 and in a card 504. As those of ordinary skill in the art recognize, the Subscriber Identity Module 500 may be used in conjunction with many communications devices (such as the user's mobile smartphone 250 illustrated in FIGS. 6 & 9). The Subscriber Identity Module 500 stores user information (such as the user's International Mobile Subscriber Identity, the user's Kᵢ number, and other user information) and any portion of the client-side media pack algorithm 142 and/or the server-side media pack algorithm 118. As those of ordinary skill in the art also recognize, the plug 502 and the card 504 each may physically or wirelessly interface with the user's mobile smartphone 250.

FIG. 28 is a block diagram of the Subscriber Identity Module 500, whether embodied as the plug 502 of FIG. 29 or as the card 504 of FIG. 30. Here the Subscriber Identity Module 500 comprises a microprocessor 506 (μP) communicating with memory modules 508 via a data bus 510. The memory modules 508 may include Read Only Memory (ROM) 512, Random Access Memory (RAM) and/or flash memory 514, and Electrically Erasable-Programmable Read Only Memory (EEPROM) 516. The Subscriber Identity Module 500 stores some or all of the client-side media pack algorithm 142 and/or the server-side media pack algorithm 118 in one or more of the memory modules 508. FIG. 28 illustrates the client-side media pack algorithm 142 and/or the server-side media pack algorithm 118 residing in the Erasable-Programmable Read Only Memory 516, yet either module may alternatively or additionally reside in the Read Only Memory 512 and/or the Random Access/Flash Memory 514. An Input/Output module 518 handles communication between the Subscriber Identity Module 500 and the communications device. Because Subscriber Identity Modules are well known in the art, this patent will not further discuss the operation and the physical/memory structure of the Subscriber Identity Module 500.

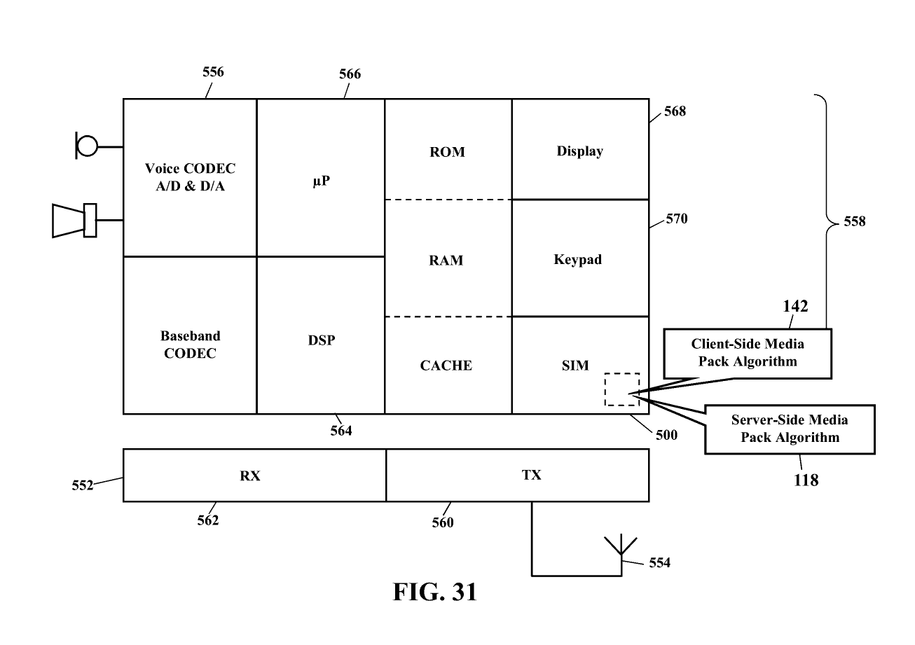

FIG. 31 is a schematic further illustrating the operating environment, according to exemplary embodiments. FIG. 31 is a block diagram illustrating some componentry of the user's computing device 140 and/or the server 110. The componentry may include one or more radio transceiver units 552, an antenna 554, a digital baseband chipset 556, and a man/machine interface (MMI) 558. The transceiver unit 552 includes transmitter circuitry 560 and receiver circuitry 562 for receiving and transmitting radio-frequency (RF) signals. The transceiver unit 552 couples to the antenna 554 for converting electrical current to and from electromagnetic waves. The digital baseband chipset 556 contains a digital signal processor (DSP) 564 and performs signal processing functions for audio (voice) signals and RF signals. As FIG. 31 shows, the digital baseband chipset 556 may also include an on-board microprocessor 566 that interacts with the man/machine interface (MMI) 558. The man/machine interface (MMI) 558 may comprise a display device 568, a keypad 570, and the Subscriber Identity Module 500. The on-board microprocessor 566 may also interface with the Subscriber Identity Module 500 and with the client-side media pack algorithm 142 and/or the server-side media pack algorithm 118.

Exemplary embodiments may be applied to any signaling standard. As those of ordinary skill in the art recognize, FIGS. 28-31 may illustrate a Global System for Mobile (GSM) communications device. That is, the computing device 140 and/or the server 110 may utilize the Global System for Mobile (GSM) communications signaling standard. Those of ordinary skill in the art, however, also recognize that exemplary embodiments are equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard. Exemplary embodiments may also be applied to other standards, such as the I.E.E.E. 802 family of standards, the Industrial, Scientific, and Medical band of the electromagnetic spectrum, BLUETOOTH®, and any other.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for encrypting media packs, as the above paragraphs explained.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A method, comprising:
a. receiving, by a server, an electronic confirmation associated with a financial transaction, the confirmation comprising a data field containing a payment-gateway-assigned identification associated with the financial transaction;
b. creating, by the server, an encryption key; and
c. encrypting, by the server, a media pack using the encryption key to generate an encrypted media pack, wherein, the encrypted media pack is keyed to a specific user's account.

2. The method of claim 1, further comprising randomly selecting, by the server, characters contained within the data field containing the payment-gateway-assigned identification, and wherein the encryption key is created using the characters randomly selected from the data field containing the payment-gateway-assigned identification.

3. The method of claim 2, further comprising receiving a cardholder's name associated with the financial transaction.

4. The method of claim 3, further comprising randomly selecting additional characters contained within the cardholder's name.

5. The method of claim 4, further comprising creating the encryption key using the additional characters randomly selected from the cardholder's name.

6. The method of claim 1, further comprising generating a user name using the characters from the data field containing the payment-gateway-assigned identification.

7. The method of claim 1, further comprising generating a purchase code using the characters from the data field containing the payment-gateway-assigned identification.

8. The method of claim 1, further comprising generating a code using the characters from the data field containing the payment-gateway-assigned identification.

9. A system, comprising:
a. a processor; and
b. a memory storing instructions that when executed cause the processor to perform operations, the operations comprising:
i. receiving an electronic confirmation of a financial transaction, the confirmation comprising a data field containing a payment-gateway-assigned identification associated with the financial transaction;
ii. creating an encryption key; and
iii. generating an encrypted media pack using the encryption key, and wherein, the encrypted media pack is keyed to a specific user's account.

10. The system of claim 9, the operations further comprising randomly selecting, by the server, characters contained within the data field containing the payment-gateway-assigned identification, and wherein the encryption key is created using the characters randomly selected from the data field containing the payment-gateway-assigned identification.

11. The system of claim 10, wherein the operations further comprise receiving a cardholder's name associated with the financial transaction.

12. The system of claim 11, wherein the operations further comprise randomly selecting additional characters contained within the cardholder's name.

13. The system of claim 12, wherein the operations further comprise creating the encryption key using the additional characters randomly selected from the cardholder's name.

14. The system of claim 9, wherein the operations further comprise generating a user name using the characters from the data field containing the payment-gateway-assigned identification.

15. The system of claim 9, wherein the operations further comprise generating a purchase code using the characters from the data field containing the payment-gateway-assigned identification.

16. The system of claim 9, wherein the operations further comprise generating a code using the characters from the data field containing the payment-gateway-assigned identification.

17. A memory device storing instructions that when executed cause a processor to perform operations, the operations comprising:
a. receiving an electronic confirmation of a financial transaction, the confirmation comprising a data field containing a payment-gateway-assigned identification associated with the financial transaction;
b. creating an encryption key; and
c. generating an encrypted media pack using the encryption key, and wherein, the encrypted media pack is keyed to a specific user account.

18. The memory of claim 17 the operations further comprising randomly selecting, by the server, characters contained within the data field containing the payment-gateway-assigned identification, and wherein the encryption key is created using the characters randomly selected from the data field containing the payment-gateway-assigned identification.

19. The memory of claim 18, wherein the operations further comprise receiving a cardholder's name associated with the financial transaction.

20. The memory of claim 19, wherein the operations further comprise randomly selecting additional characters contained within the cardholder's name.

21. The memory of claim 20, wherein the operations further comprise creating the encryption key using the additional characters randomly selected from the cardholder's name.

22. The memory of claim 17, wherein the operations further comprise generating a user name using the characters from the data field containing the payment-gateway-assigned identification.

23. The memory of claim 17, wherein the operations further comprise generating a purchase code using the characters from the data field containing the payment-gateway-assigned identification.
